(19) United States
(12) Patent Application Publication
(10) Pub. No.: US 2026/0008085 A1
(43) Pub. Date: Jan. 8, 2026

(54) METHODS TO REMEDIATE SOIL CONTAMINATED WITH POLY- AND/OR PERFLUORO ALKYL SUBSTANCES (PFAS), AND/OR OTHER ANIONIC ORGANIC CONTAMINANTS

(71) Applicant: GOVERNMENT OF THE UNITED STATES AS REPRESENTED BY THE ADMINISTRATOR OF THE U.S., Washington, DC (US)

(72) Inventors: John WASHINGTON, Washington, DC (US); Marina EVICH, Washington, DC (US)

(73) Assignee: GOVERNMENT OF THE UNITED STATES AS REPRESENTED BY THE ADMINISTRATOR OF THE U.S., Washington, DC (US)

(21) Appl. No.: 18/763,889

(22) Filed: Jul. 3, 2024

(51) Int. Cl. B09C 1/08; B09C 1/00

(52) U.S. Cl. CPC B09C 1/08; B09C 1/002; B09C 2101/00

(57) ABSTRACT

A method to remediate soil contaminated with anionic organic contaminants by electrostatically immobilizing the anionic organic contaminants, including: adding a soluble aluminum salt solution onto or into the soil; and adding an alkaline solution onto or into the soil to precipitate aluminum hydroxide solids having a formula of roughly Al(OH) 3 in-situ, and adjust the pH of the soil to a level that balances insolubility against positive electrostatic surface charge.

### BACKGROUND OF THE INVENTION

### 1. Field of the Invention

Aspects of this invention constitute methods to remediate soil contaminated with poly- and/or perfluoro alkyl substances (PFAS), by electrostatic immobilization of the contaminants or mobilization for controlled recovery by pump-and-treat or similar approaches.

### 2. Description of the Related Art

PFAS are versatile anthropogenic compounds designed for diverse applications including, i) to impart anti-wetting and anti-staining properties to consumer and industrial products, ii) diminish friction between moving parts in mechanical devices, iii) offer electrical resistance properties, iv) improve resistance to environmental heat, among other uses. With this wide array of uses in modern society, PFAS have found their way into the environment during industrial synthesis, during use and at end-of-life stages (Evich et al. (2022). “Per- and polyfluoroalkyl substances in the environment.” Science 375 (6580): eabg9065). In the environment, PFAS are highly persistent and can be mobile (Evich et al. (2022). “Per- and polyfluoroalkyl substances in the environment.” Science 375 (6580): eabg9065).

Whereas PFAS are known to contaminate much of our environment at ambient levels (Washington et al. (2019). “Determining global background soil PFAS loads and the fluorotelomer-based polymer degradation rates that can account for these loads.” Science of the Total Environment 651:2444-2449), there are numerous types of sites that have been found to be particularly highly contaminated with PFAS including i) industrial manufacturing and use facilities and surrounding lands, ii) airports and fire-fighting training centers that have used aqueous film-forming foam (AFFF), iii) Department of Defense (DOD) and Department of Energy (DOE) facilities, iv) agricultural and other lands upon which industrial or municipal biosolids or sludge have been applied, and v) lands on which treated wastewater has been sprayed.

At these sites, PFAS have been found at high concentrations in the surface and subsurface soils. Absent remedial measures to control PFAS fate, these high PFAS soil concentrations can be mobilized in soil water for uptake into vegetation (Davis et al. (2023). “Environmental Fate of CI-PFPECAs: Accumulation of Novel and Legacy Perfluoroalkyl Compounds in Real-World Vegetation and Subsoils.” Environmental Science & Technology) and/or leaching to groundwater aquifers (Lindstrom et al. (2011). “Application of WWTP Biosolids and Resulting Perfluorinated Compound Contamination of Surface and Well Water in Decatur, Alabama, USA.” Environmental Science & Technology 45 (19): 8015-8021, McCord, J. P. et al. (2020). “Emerging chlorinated polyfluorinated polyether compounds impacting the waters of southeastern New Jersey. Identified by use of nontargeted analysis.” Environmental Science & Technology Letters 7:903-908). In turn, impacted vegetation and/or groundwater subsequently can be consumed by humans and/or other biota.

Exposure to high doses of PFAS is recognized to be toxic to humans and other biota by numerous modes of action.

Consequently, at these sites that are highly contaminated with PFAS, it is desirable to control such potential PFAS exposure through contaminated routes including vegetation or water. Here we report in-situ methods to electrostatically immobilize PFAS in the contaminated soils and/or mobilize it for subsequent controlled recovery. Whereas this invention centrally focuses on PFAS, the invention and all discussion herein is intended to be relevant for remediation of other anionic organic contamination as well.

### SUMMARY OF THE INVENTION

The invention describes methods by which aluminum (oxy) hydroxide mineral (oid) s can be manipulated to electrostatically immobilize PFAS and/or to remobilize PFAS for subsequent controlled recovery.

Based upon research conducted over the last several years, we have identified aluminum (oxy) hydroxide mineral (oid) s as naturally occurring solids that are formed in soils, are stable in soils, and are effective in binding PFAS by electrostatic sorption, thereby diminishing the contaminants' mobility. This observation has been confirmed in peer-reviewed scientific literature wherein aluminum solids have been mixed into contaminated soils to successfully immobilize the PFAS (Sorengard, M. et al. (2019). “Stabilization and solidification remediation of soil contaminated with poly- and perfluoroalkyl substances (PFASs).” Journal of Hazardous Materials 367:639-646, Braunig, J. et al. (2021). “Sorbent assisted immobilisation of perfluoroalkyl acids in soils-effect on leaching and bioavailability.” Journal of Hazardous Materials 412:125171, Kabiri et al. 2021, McDonough, J. et al. (2022). “Field-Scale Demonstration of PFAS Leachability Following In Situ Soil Stabilization.” ACS Omega 7:419-429).

Aspects of the present invention improve upon present state-of-the-art technology:
1) To electrostatically immobilize PFAS in-situ, our approach distributes aluminum solids through a soil profile (or other subsurface settings) by aqueous addition (e.g., watering by sprinkler or injection via temporary wells) of soluble salts of aluminum, e.g., AlCl₃ or Al₂ (SO₄)₃, followed by subsequent precipitation of the aluminum solids by addition of alkaline waters, e.g., Ca(OH)₂, in amounts that are as much as stoichiometric with the aluminum (in some settings, natural buffering might diminish the amount of alkaline needed), e.g., approximately 2AlCl₃+3Ca(OH)₂→2Al(OH)₃+3Ca²⁺+6Cl⁻, wherein the resultant Al(OH)₃ solids will bear positive surface charge at typical subsurface pH ranges thereby offering a sorption substrate for anionic PFAS; and
2) Alternatively, to mobilize PFAS for subsequent controlled recovery, e.g., pump-and-treat of groundwater, alkaline water is added to the soil to increase subsurface soil pH to roughly the zero-point of charge (ZPC) of the aluminum solids, thereby fostering release of PFAS from aluminum solids and other authigenic mineral (oid) s having pH-dependent surface charges, e.g., ferric (oxy) hydroxide mineral (oid) s, so the PFAS-laden water can percolate to the water table, and then flow under controlled conditions to recovery wells.

Thus, aspects of the invention provide for the following:
1) The ability to enhance in-situ immobilization without having to ‘excavate contaminated soils, mix the soils with adsorbent, replace and recontour the soils, and revegetate’. Taken together, these remedial activities that our method renders unnecessary typically constitute the largest part of costs of such expensive remediation activities.
2) A more fundamental understanding of the relevance and chemistry of sorption on these solids than hitherto has been invoked in in-situ PFAS soil remediation, allowing for enhanced controlled recovery of PFAS and/or other anionic contaminants.

According to an aspect of the invention, a method to remediate soil contaminated with anionic organic contaminants by electrostatically immobilizing the anionic organic contaminants, comprises: adding a soluble aluminum salt solution onto or into the soil; and adding an alkaline solution onto or into the soil to precipitate aluminum hydroxide solids having a formula of roughly Al(OH)₃ in situ, and adjust the pH of the soil to a level that balances insolubility against positive electrostatic surface charge.

According to an aspect of the invention, a method of mobilizing contaminants sorbed on naturally occurring Al(OH)₃ solids comprises: adding alkaline solution onto or into the soil in order to raise the pH of the soil to a range of 9 to 10, thereby neutralizing the positive electrostatic surface charge on the Al(OH)₃ solids in the soil, thus eliminating the ionic immobilization of the anionic contaminants on the Al(OH)₃ and freeing the anionic organic contaminants, and subsequently removing and recovering the anionic contaminant by pumping-and-treating the groundwater.

According to an aspect of the invention, a method to further remediate soil that has been treated by the method according to claim 1 by re-mobilizing the anionic organic contaminants, comprises: adding additional alkaline solution onto or into the soil in order to raise the pH of the soil to a range of 9 to 10, thereby neutralizing the positive electrostatic surface charge on the Al(OH)₃ solids in the soil, thus eliminating the ionic immobilization of the anionic contaminants on the Al(OH)₃ and freeing the anionic organic contaminants, and subsequently removing and recovering the anionic contaminant by pumping-and-treating the groundwater

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 shows a method to remediate soil contaminated with anionic organic contaminants by electrostatically immobilizing the anionic organic contaminants.

FIG. 2 shows a method to remediate soil contaminated with anionic organic contaminants by adding alkaline solution to the soil, thereby mobilizing the anionic organic contaminants that are electrostatically sorbed to naturally occurring soil mineral(oid)s for pump-and-treat recovery.

FIG. 3 shows a method to remediate soil contaminated with anionic organic contaminants by first electrostatically immobilizing them and then remobilizing them for pump-and-treat recovery.

FIG. 4 shows the electrostatic surface charge of hydrous aluminum oxide in an example soil from South Carolina as a function of pH at three solution ionic strengths; 0.5, 0.05 and 0.005.

FIGS. 5A, 5B, 5C and 5D relate to data from two example soils from South Carolina through depth. In all cases the vertical axis is the Log of perfluorohexanoic acid (PFHxA; normalized to average surface concentration).

FIG. 6 shows the thermodynamic speciation diagram for aluminum. Calculations for 25° C., 1 bar and saturated with water, using thermodynamic dataset ‘thermo.tdat’ in Geochemist's Workbench (AqueousSolutions 2023) for aqueous speciation and gibbsite, and adding thermodynamic data for amorphous Al(OH)₃ and microcrystalline gibbsite as reported in Nordstrom et al. (Nordstrom, D. K. et al. (1984). Partial Compilation and Revision of Basic Data in the WATEQ Programs. Menlo Park, CA, U.S. Geological Survey)

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below to explain the present invention by referring to the figures.

This invention comprises improved methods to manipulate the mobility of PFAS and other anionic organic contaminants in soils and other subsurface settings.

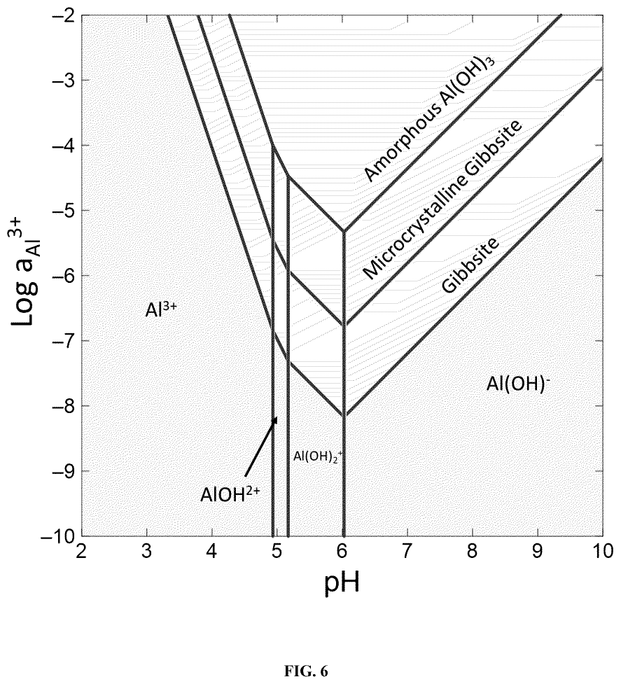

FIG. 1 shows method 100 to remediate soil contaminated with anionic organic contaminants by electrostatically immobilizing the anionic organic contaminants. In step 110, soluble aluminum salt solution is added onto or into the contaminated soil. In step 120, alkaline solution is added onto or into the soil to precipitate Al(OH)₃ solids and adjust the pH of the soil to a level that balances insolubility against positive electrostatic surface charge. This pH is 4.9 to 5.0 according to FIG. 6.

The alkaline solution contains at least one of bases: calcium hydroxide Ca(OH)₂), calcium oxide (CaO), or sodium hydroxide (NaOH).

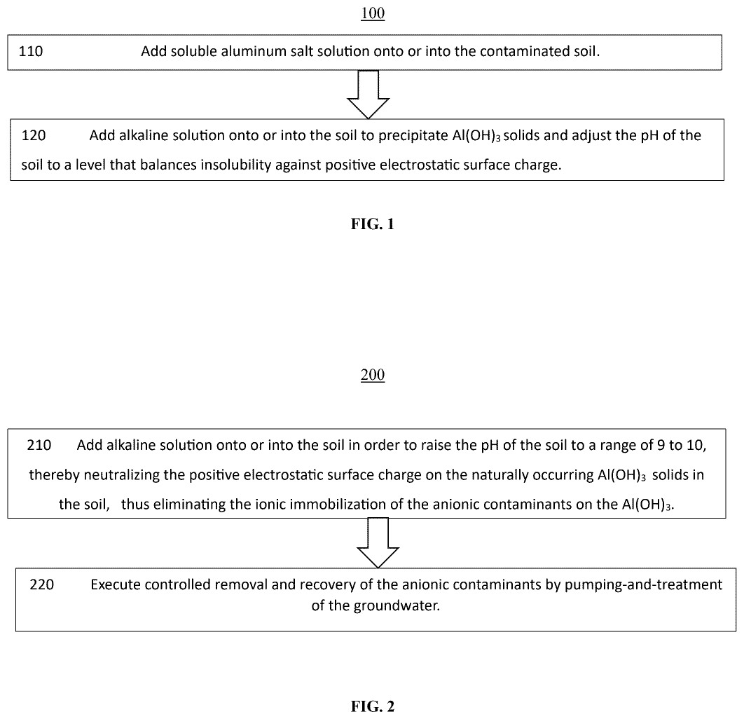

FIG. 2 shows method 200 to remediate soil contaminated with anionic organic contaminants by electrostatically mobilizing the anionic contaminants immobilized on naturally occurring Al(OH)₃ for pump and treat recovery. In step 210 alkaline solution is added onto or into the soil in order to raise the pH of the soil to a range of 9 to 10, thereby neutralizing the positive electrostatic surface charge on the Al(OH)₃ solids in the soil, and eliminating the electrostatic immobilization of the anionic contaminants on the Al(OH)₃. In step 220 controlled removal and recovery of the anionic contaminants is carried out by pumping-and-treatment of the groundwater.

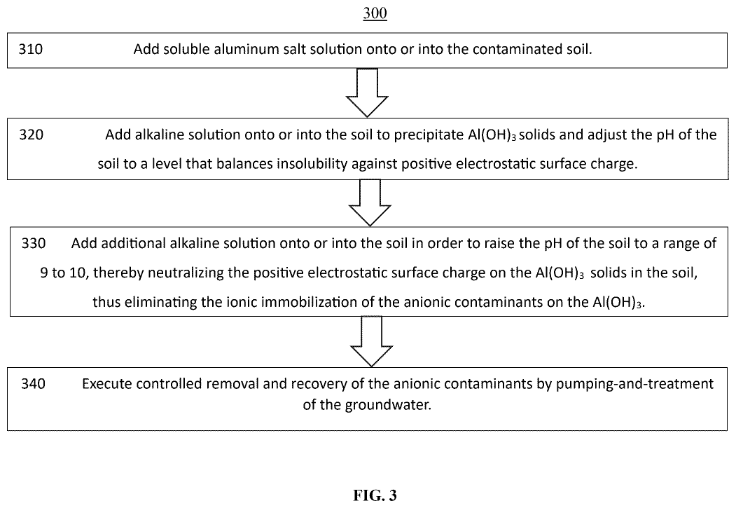

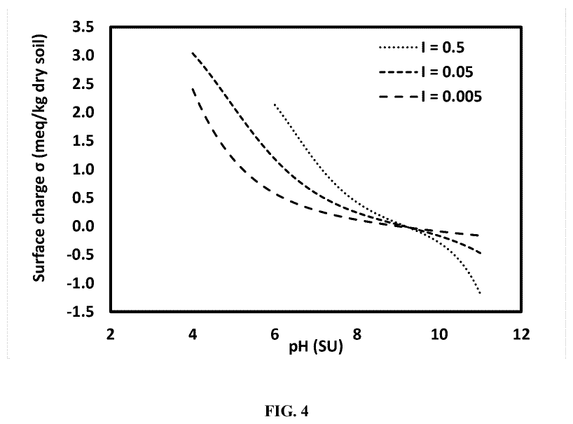

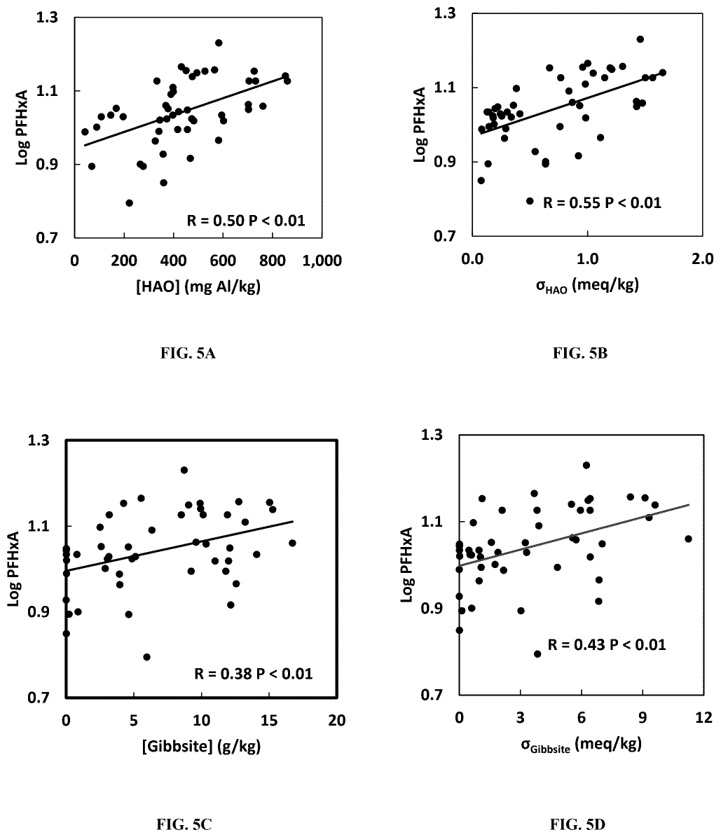

FIG. 3 shows method 300 to remediate soil contaminated with anionic organic contaminants by first electrostatically immobilizing the anionic organic contaminants in steps 310 and 320 and then remobilizing the anionic contaminant in step 330 by adding additional alkaline solution onto or into the soil in order to raise the pH of the soil to a range of 9 to 10 and then carrying out controlled removal and recovery of the anionic contaminants by pumping-and-treatment of the groundwater in step 340.

The role of authigenic mineral (oid) s in soils for immobilizing PFAS in subsurface settings was investigated. Among these mineral (oid) s the content of gibbsite (crystalline Al(OH)₃) and amorphous hydrous aluminum oxide (HAO; roughly of the formula Al(OH)₃) was measured. In the following discussion, we intend this patent to be inclusive of all aluminum solid crystalline polymorphs, including, but not limited to, gibbsite, boehmite, pseudoboehmite, diaspore, nordstrandite, bayerite, hydrargillite, doylite, the noncrystalline solids HAO and allophane, and the geologic deposits bauxite and laterite, as all these solids will have similar functional properties regarding electrostatic surface charge that is a function of pH and ionic strength.

For these aluminum solids equation (1) relating electrostatic surface charge (o) to pH and ionic strength (I) was solved using the generalized two-layer model of Dzombak and Morel (Dzombak, D. A. and F. M. M. Morel (1990). Surface Complexation Modeling: Hydrous Ferric Oxide. New York, NY, John Wiley & Sons) and Karamalidis and Dzombak (Karamalidis, A. K. and D. A. Dzombak (2010). Surface Complexation Modeling: Gibbsite. Hoboken, NJ, John Wiley & Sons):

$$σ = \{ [ ( \frac{Tot ( {x}^{s} OH )}{\frac{{a}_{H} + P}{{K}_{a 1}^{int}} + 1 + \frac{{K}_{a 2}^{int}}{{a}_{H} + P}} ) + ( \frac{Tot ( {x}^{w} OH )}{\frac{{a}_{H} + P}{{K}_{a 1}^{int}} + 1 + \frac{{K}_{a 2}^{int}}{{a}_{H} + P}} ) ] [ ( \frac{{a}_{H} + P}{{K}_{a 1}^{int}} ) - ( \frac{{K}_{a 2}^{int}}{{a}_{H} + P} ) ] \} \qquad ( 1 )$$

where Tot(x^{s}OH) is the total strong (complexation) protonation-deprotonation sites per mineral(oid) cation (i.e., Al) (mol/mol), Tot (x^{w}OH) is the total weak (electrostatic) protonation-deprotonation sites per mineral (oid) cation, a_{H+} is the bulk aqueous proton activity (i.e., 10^{-pH}), Ka₁^{int} is the intrinsic equilibrium constant defining the chemical equilibrium component of potential energy for deprotonating a neutrally charged site (i.e., xOH⁰→xO⁻), Kₐ₂^{int} is the intrinsic equilibrium constant defining the chemical equilibrium component of potential energy for deprotonating a positively charged site (i.e., xOH²⁺→OH⁰), and P is the “coulombic correction factor”.

Conceptually, P expresses the electrostatic equilibrium component of potential energy for specified pH and I in common form with chemical potential by the relation P=exp (−FΨ/RT) where F is Faraday's constant, Y is aqueous diffuse-layer potential (coulombs), R is the Ideal Gas constant, and T is absolute temperature. Values of log P for gibbsite are tabulated in the mineral equilibrium model MINEQL+ V5.0, which was regressed for selected values of I using a quadratic fit.

With this calculation as background, an important fundamental concept for the purpose of this invention is that the further the pH is below the ZPC of ˜9.18 and the higher the solution ionic strength, the higher the capacity of the aluminum solids to electrostatically immobilize PFAS and other anionic contaminants. This relationship is depicted in FIG. 4.

FIG. 4 shows the electrostatic surface charge of hydrous aluminum oxide in an example soil from South Carolina as a function of pH at three solution ionic strengths; 0.5, 0.05 and 0.005.

The PFAS distribution was then compared to the distribution of these aluminum solids' concentrations and their electrostatic charges, finding that the short and intermediate chain (i.e., C4 through C9) PFAS distribution were highly positively correlated with the aluminum solids concentration and electrostatic charge. An example of the correlative relationships between PFAS and aluminum solids' concentrations and their electrostatic charges is depicted in FIG. 5A through FIG. 5D. The distribution of PFHxA is highly correlated with HAO or gibbsite concentration and electrostatic charge. For both HAO and gibbsite, the correlation coefficient is higher for charge than it is for concentration.

In FIG. 5A, the horizontal axis is the amorphous hydrous aluminum oxide concentration, in FIG. 5B it is the amorphous aluminum oxide surface charge. In FIG. 5C, it is the gibbsite mineral (oid) concentrations and in FIG. 5D it is the gibbsite mineral (oid) electrostatic charge. The distribution of PFHxA is highly correlated with HAO and gibbsite concentration and electrostatic charge. For both HAO and gibbsite, the correlation coefficient is higher for charge than it is for concentration

Our data indicating the immobilization of PFAS in subsurface soils by aluminum solids is consistent with the findings of numerous studies (Sorengard, M. et al. (2019). “Stabilization and solidification remediation of soil contaminated with poly- and perfluoroalkyl substances (PFASs).” Journal of Hazardous Materials 367:639-646, Braunig, J. et al. (2021). “Sorbent assisted immobilisation of perfluoroalkyl acids in soils-effect on leaching and bioavailability.” Journal of Hazardous Materials 412:125171, Kabiri, S. et al. (2021). “Durability of sorption of per- and polyfluorinated alkyl substances in soils immobilized using common adsorbents: 2. Effects of repeated leaching, temperature extremes, ionic strength and competing ions.” Science of The Total Environment 766:144718, McDonough, J. et al. (2022). “Field-Scale Demonstration of PFAS Leachability Following In Situ Soil Stabilization.” ACS Omega 7:419-429) in which a proprietary powdered blend containing the aluminum mineral pseudoboehmite was mixed into contaminated soils to find a decrease in PFAS leachability with the amendments, commonly on the order of 99% reduction. The aluminum solids added to soil in these studies required excavation of contaminated soils, mixing with the amendment, redepositing and recontouring of the mixed soils, and revegetation. Below is described how to add the aluminum solids to in-place contaminated soils or contaminated aquifers with no excavation or additional soil handling required.

In these studies, (Sorengard, M. et al. (2019). “Stabilization and solidification remediation of soil contaminated with poly- and perfluoroalkyl substances (PFASs).” Journal of Hazardous Materials 367:639-646, Braunig, J. et al. (2021). “Sorbent assisted immobilisation of perfluoroalkyl acids in soils-effect on leaching and bioavailability.” Journal of Hazardous Materials 412:125171, Kabiri, S. et al. (2021). “Durability of sorption of per- and polyfluorinated alkyl substances in soils immobilized using common adsorbents: 2. Effects of repeated leaching, temperature extremes, ionic strength and competing ions.” Science of The Total Environment 766:144718, McDonough, J. et al. (2022). “Field-Scale Demonstration of PFAS Leachability Following In Situ Soil Stabilization.” ACS Omega 7:419-429), the addition rate of added aluminum solids generally was 5% to 10% aluminum solids mass added per mass of dry soil. Examining the general magnitude of impact of this addition rate on the porosity of in-situ soils by the described methods, consider this example. Typical soil bulk density (ρ_{b}) is 1.5 g/cm³. A representative particle density of soil minerals is that of quartz, 2.65 g/cm³ (ρₚ). For these values, typical soil porosity (P) is given by:

$$P = 1 - \frac{{ρ}_{b}}{{ρ}_{p}} = 1 - \frac{1.5}{2.65} = 0.434 \qquad ( 2 )$$

where P has units of cm³ₚₒᵣₑₛ/cm³ₜₒₜₐₗ. Adding aluminum solids at 5% rate increases post-treatment bulk density by 1.5*1.05=1.575 g/cm³ equating to P=0.406. Adding aluminum solids at 10% rate increases post-treatment bulk density by 1.5*1.10=1.65 g/cm³ equating to P=0.377. So, the rates of aluminum-addition used in the literature will not impact porosity prohibitively using the in-situ addition methods we describe.

Dispersion of the aluminum solids from the point of addition will be a complex function of pH of the Al solution, soil pH, soil cation-exchange capacity (CEC) and soil buffer capacity. The dispersivity of Al will tend to be greatest at pHs below that of the stability field of the most-stable low-pH hydrolysis complex. Using thermodynamic dataset ‘thermo.tdat’ in Geochemist's Workbench (AqueousSolutions 2023), the first hydrolysis complexation falls at roughly pH 4.9 to 5.0 as shown in FIG. 6.

Addition of aluminum solids to contaminated soils is carried out with aqueous solutions of aluminum chloride (AlCl₃) or aluminum sulfate (Al₂ (SO₄)₃), calcium oxide (CaO; lime), perhaps buffered by sodium hydroxide (NaOH) and sodium citrate (Na₃C₆H₅O₇) as needed in some applications, the proportions of each depending upon where the aluminum solids are desired, surface soil, subsurface soil, aquifer, how the aluminum is added to the soil, surface sprinkling vs injection, as well as geochemical conditions and degree of aluminum solids dispersion desired.

Additional aluminum solids required to immobilize PFAS in surface soil: Adding aluminum solids to surface soils requires very little mobility of aluminum before precipitation of solids, so buffer agents likely are unnecessary. To add these solids, prepare an Al salt solution at 0.25 molar (e.g., [AlCl₃]=33 g/L), consistent with the laboratory synthesis methods of Sato (Sato 1988). Then to add 5% Al(OH)₃ g per g dry soil, the desired mass is 1.5 g/cm³*0.05=0.075 g Al(OH)₃/cm³ soil. The stoichiometric amount of AlCl₃ solution to add to soil then is 3850 LAlCl₃ solution/m³ dry soil. Taking the surface soil as a 10 cm deep slice of soil, this equates to 385 LAlCl₃ solution added per m² of soil surface area. In turn, this equates to 38 cm solution. Assuming a watering rate of 10 cm/week, this requires roughly four weeks of solution addition. Then to immobilize the Al, up to three moles of OH⁻ is required for every mole of Al added. Addition of the AlCl₃ solution will drop soil pH by dint of Al³⁺ scavenging OH⁻ to form Al(OH)₂⁺, Al(OH)₃⁰ and the desired Al(OH)_{3solid}. Given the site-specific complex interplay of pH, CEC and buffer capacity, pH is best adjusted by monitoring pH in the application zone while Ca(OH)₂ is added, with desired endpoint determined by agricultural needs, or if agricultural productivity is not a constraint, then to a pH between 4 and 6 where electrostatic surface charge is moderately high (FIG. 3). All other considerations being equal, to add alkali lime is favored over NaOH because the divalent Ca²⁺ will tend not to puddle the soils (i.e., disaggregate secondary soil structure, in turn disrupting several soil properties) whereas Na⁺ can cause puddling.

Additional aluminum solids required to immobilize PFAS in the subsurface: In well-developed soils, with increasing depth, pH commonly drops abruptly from the common range of surface soils. Moderately acidic subsurface pHs are fostered by microbial oxidation of humic materials winnowing through soil profiles, raising CO₂ in excess of atmospheric levels, with attendant elevation of carbonic acid to impose moderately acidic conditions (Washington, J. W. et al. (2004). “Kinetic control of oxidation state at thermodynamically buffered potentials in subsurface waters.” Geochimica et Cosmochimica Acta 68 (23): 4831-4842). Nordstrom and Ball (Nordstrom, D. K. and J. W. Ball (1986). “The geochemical behavior of aluminum in acidified surface waters.” Science 232 (4746): 54-56) argue that, in aluminosilicate-rich settings, acidic pHs commonly are buffered by dissolution/precipitation of HAO and micro-crystalline gibbsite to the pH range 4.6 to 4.9, similar to the buffered pH=4.65 for hydrolysis of Al³⁺═Al(OH)₂+ (Equation 3), as well as the pH range reported for spring-waters issuing from weathered soils for a >2-year period in Georgia (2-year range=4.31-5.18) (Washington, J. W. et al. (2004). “Kinetic control of oxidation state at thermodynamically buffered potentials in subsurface waters.” Geochimica et Cosmochimica Acta 68 (23): 4831-4842). In this general pH range, injected Al mobility will remain high until neutralized naturally by the soil system or perhaps until alkaline is added to hydrolyze the Al³⁺. So Al addition in the subsurface might be carried out with temporary injection wells, e.g., installed with Geoprobe, in pairs with one well dedicated to Al³⁺ injection and its pair injecting the alkaline Ca(OH)₂ solution to precipitate the Al(OH)₃ solids.

Mobilizing sorbed PFAS for controlled recovery: Commonly pump-and-treat exercises are protracted activities, extending over years, with a large fraction of the contaminant reservoir present as sorbed species, and slowly partitioning through time as freshwater fluxes through the contaminated zone. The affinity of aluminum solids for sorbing PFAS and other anionic contaminants largely arises from the solid's electrostatic surface charges (FIGS. 5B and 5D).

This surface charge can be manipulated by adjusting pH (FIG. 3), wherein the surface charge fully diminishes as the ZPC is approached. For authigenic aluminum solids ZPC ˜ 9.2, so, if alkaline water, pH˜9.2, is added to contaminated soils, the attraction of PFAS and other anionic contaminants for the aluminum solids moderates, and PFAS will be flushed into bulk solution, where it will be free to migrate with advecting water to pump-and-treat recovery wells. By flushing larger fractions of PFAS over shorter periods, the investment of longer pump-and-treat periods will be decreased, greatly reducing lifetime remedial costs. It is noteworthy that the ZPC of aluminum solids (pH˜9.2), exceeds that of ferric oxides (PH˜8.1 to 8.3), so if some PFAS are sorbed to these solids (these solids tend to concentrate in surface soils), then PFAS sorbed to these solids should be released to bulk solution as well.

Thus, above are discussed aspects of this invention which include methods to remediate soil contaminated with poly- and/or perfluoro alkyl substances (PFAS), by electrostatic immobilization of the contaminants or mobilization for controlled recovery by pump-and-treat or similar approaches.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method to remediate soil contaminated with anionic organic contaminants by electrostatically immobilizing the anionic organic contaminants, comprising:
adding a soluble aluminum salt solution onto or into the soil; and
adding an alkaline solution onto or into the soil to precipitate aluminum hydroxide solids having a formula of roughly Al(OH)₃ in-situ, and adjust the pH of the soil to a level that balances insolubility against positive electrostatic surface charge.

2. The method of claim 1, wherein the contaminants are poly- and/or perfluoro alkyl substances (PFAS).

3. The method of claim 1, wherein the soluble aluminum salt solution contains the solute AlCl₃ or Al₂(SO₄)₃.

4. The method of claim 1, wherein the soluble aluminum salt solution and the alkaline solution are sprinkled onto a surface of the soil.

5. The method of claim 1, wherein the added soluble aluminum salt solution and the alkaline solution are injected into a sub-surface of the soil.

6. The method of claim 1, wherein the alkaline solution contains at least one of bases:
calcium hydroxide (Ca(OH)₂),
calcium oxide (CaO), or
sodium hydroxide (NaOH).

7. The method of claim 1, wherein the pH is adjusted to a range of 5 to 6.

8. A method of mobilizing contaminants sorbed on naturally occurring Al(OH)₃ solids comprising:
adding alkaline solution onto or into the soil in order to raise the pH of the soil to a range of 9 to 10, thereby neutralizing the positive electrostatic surface charge on the Al(OH)₃ solids in the soil, thus eliminating the ionic immobilization of the anionic contaminants on the Al(OH)₃ and freeing the anionic organic contaminants, and
subsequently removing and recovering the anionic contaminant by pumping-and-treating the groundwater.

9. The method of claim 8, wherein the contaminants are poly- and/or perfluoro alkyl substances (PFAS).

10. The method of claim 8, wherein the alkaline solution contains at least one of bases:
calcium hydroxide (Ca(OH)₂),
calcium oxide (CaO), or
sodium hydroxide (NaOH).

11. A method to further remediate soil that has been treated by the method according to claim 1 by re-mobilizing the anionic organic contaminants, comprising:
adding additional alkaline solution onto or into the soil in order to raise the pH of the soil to a range of 9 to 10, thereby neutralizing the positive electrostatic surface charge on the Al(OH)₃ solids in the soil, thus eliminating the ionic immobilization of the anionic contaminants on the Al(OH)₃ and freeing the anionic organic contaminants, and
subsequently removing and recovering the anionic contaminant by pumping-and-treating the groundwater.

12. The method of claim 11, wherein the contaminants are poly- and/or perfluoro alkyl substances (PFAS).

13. The method of claim 11, wherein the alkaline solution contains at least one of bases:
calcium hydroxide (Ca(OH)₂),
calcium oxide (CaO), or
sodium hydroxide (NaOH).
